(19) United States
(12) Patent Application Publication
(10) Pub. No.: US 2014/0151438 A1
(43) Pub. Date: Jun. 5, 2014

(54) APPARATUS TO JOIN TUBULARS USING FRICTION STIR JOINING

(71) Applicants: Rodney Dale Fleck, Mansfield, TX (US); Bonnie Powell, Houston, TX (US); Paul T. Higgins, Houston, TX (US); Rod W. Shampine, Houston, TX (US); Russell J. Steel, Salem, UT (US); Scott M. Packer, Alpine, UT (US); Edward K. Leugemors, Needville, TX (US); Timothy M. Lesko, Sugar Land, TX (US)

(72) Inventors: Rodney Dale Fleck, Mansfield, TX (US); Bonnie Powell, Houston, TX (US); Paul T. Higgins, Houston, TX (US); Rod W. Shampine, Houston, TX (US); Russell J. Steel, Salem, UT (US); Scott M. Packer, Alpine, UT (US); Edward K. Leugemors, Needville, TX (US); Timothy M. Lesko, Sugar Land, TX (US)

(21) Appl. No.: 13/894,250

(22) Filed: May 14, 2013

Related U.S. Application Data
(60) Provisional application No. 61/646,878, filed on May 14, 2012.

(51) Int. Cl. B23K 20/12

(52) U.S. Cl. CPC B23K 20/1225; B23K 20/123
USPC 228/104; 228/2.1; 228/112.1; 228/114; 228/103

(57) ABSTRACT

A system and method for repairing and/or joining together multiple lengths of tubulars using friction stir joining, and a system for manipulating the tubular so that friction stir joining may be performed while the tubular is on a reel and/or at a field site.

### BACKGROUND

### Description of Related Art

Friction stir joining is a technology that has been developed for welding metals and metal alloys. Friction stir welding is generally a solid state process that has been researched, developed and commercialized over the past 20 years. Solid state processing is defined herein as a temporary transformation into a plasticized state that may not include a liquid phase. However, it is noted that some embodiments allow one or more elements to pass through a liquid phase.

Friction stir joining began with the joining of aluminum materials because friction stir joining tools could be made from tool steel and adequately handle the loads and temperatures that are needed to join aluminum. Friction stir joining has continued to progress into higher melting temperature materials such as steels, nickel base alloys and other specialty materials because of the development of superabrasive tool materials and tool designs capable of withstanding the forces and temperatures needed to flow these higher melting temperature materials.

It is understood that the friction stir joining process often involves engaging the material of two adjoining planar workpieces on either side of a joint by a rotating stir pin. Force is exerted to urge the pin and the workpieces together and frictional heating caused by the interaction between the pin, shoulder and the workpieces results in plasticization of the material on either side of the joint. The pin and shoulder combination or “FSW tip” is traversed along the joint, plasticizing material as it advances, and the plasticized material left in the wake of the advancing FSW tip cools to form a weld. The FSW tip may also be a tool without a pin so that the shoulder is processing another material through FSP.

FIG. 1 is a perspective view of a tool being used for friction stir joining that is characterized by a generally cylindrical tool 10 having a shank, a shoulder 12 and a pin 14 extending outward from the shoulder. The pin 14 is rotated against a workpiece 16 until sufficient heat is generated, at which point the pin of the tool is plunged into the plasticized planar workpiece material. In this example, the pin 14 is plunged into the planar workpiece 16 until reaching the shoulder 12 which prevents further penetration into the workpiece. The planar workpiece 16 is often two sheets or plates of material that are butted together at a joint line 18. In this example, the pin 14 is plunged into the planar workpiece 16 at the joint line 18.

Referring to FIG. 1, the frictional heat caused by rotational motion of the pin 14 against the planar workpiece material 16 causes the workpiece material to soften without reaching a melting point. The tool 10 is moved transversely along the joint line 18, thereby creating a weld as the plasticized material flows around the pin from a leading edge to a trailing edge along a tool path 20. The result is a solid phase bond at the joint line 18 along the tool path 20 that may be generally indistinguishable from the workpiece material 16, in contrast to the welds produced when using conventional non-FSW welding technologies.

It is observed that when the shoulder 12 contacts the surface of the planar workpieces, its rotation creates additional frictional heat that plasticizes a larger cylindrical column of material around the inserted pin 14. The shoulder 12 provides a forging force that contains the upward metal flow caused by the tool pin 14.

During friction stir joining, the area to be joined and the tool are moved relative to each other such that the tool traverses a desired length of the weld joint at a tool/workpiece interface. The rotating friction stir welding tool 10 provides a continual hot working action, plasticizing metal within a narrow zone as it moves transversely along the base metal, while transporting metal from the leading edge of the pin 14 to its trailing edge. As the weld zone cools, there is no solidification as no liquid is created as the tool 10 passes. It is often the case, but not always, that the resulting weld is a defect-free, re-crystallized, fine grain microstructure formed in the area of the weld.

In the present state of the art, arcuate or curved surfaces such as pipes or tubes are joined together by butting the ends of the tubing together, inserting a support mandrel from an open end of the tubing under the joint, and then performing friction stir joining of the tubing. This concept has already been disclosed in patents and publications and is widely accepted as an effective means of joining curved surfaces together. The terms “tubular”, “coiled tubing”, “tube”, “tubing”, “drillpipe”, “casing”, and “pipe” and other like terms can be used interchangeably. The terms may be used in combination with “joint”, “segment”, “section”, “string” and other like terms referencing a length of tubular.

Coiled tubing is a means of conveyance of fluid in an oilfield, and its value is in the fact that the coiled tubing is continuous. However, when the coiled tubing is damaged, it is difficult to repair. Repair of the coiled tubing may mean that the entire coil of tubing is wound onto a large spool or reel and taken back to a repair facility. The damaged section of coiled tubing is removed, and then the ends of the coiled tubing are welded together.

During manufacturing, such joints may be made at the factory using a scarf joint before the coiled tubing is rolled into a tube. The scarf joint is done at a roughly 45 degree angle to the length of a steel strip and may be heat treated, ground flush on both sides, and thoroughly inspected before welding the steel strip into a tube. However, joints on the round coiled tubing may be more complicated to make and may be less reliable than when originally manufactured.

Even the best butt-welded joint may not last for more than half of the coiled tubes' rated fatigue life. This is because basic tensile and hoop stress properties may be compromised. One reason for this is that when making the weld, the welder does not have access to the inside of the tubing to control the internal profile of the weld.

Coiled tubing may be used in oil wells that are deep beneath the surface. It is difficult to extend coiled tubing to these depths. Coiled tubing sections or lengths may not be inserted and connected together like drill pipe or casing since each joint may not maintain pressure and may leak fluid. The need for a continuous length of coiled tubing has created an industry that manufactures it. However, some issues have arisen with the use of coiled tubing.

For example, a coiled tubing manufacturer purchases steel strip and welds each strip together in order to have a length of strip long enough to manufacture a roll of coiled tubing. This weld is performed as a bias weld. A bias weld is used because the tubing is coiled and uncoiled on a large reel because of its continuous length. The bias weld minimizes the potential of fatigue and weld related failures from occurring during the coiling and uncoiling process.

Once several strips have been bias welded together to form the desired length of tubing, it is seam welded into a continuous length of tubing and placed on a coil. These coils may be as large as 25 feet in diameter. Coiled tubing will often fail at these bias welds. Each time the coil tubing is uncoiled and recoiled, the tubing experiences plastic deformation, and the bias weld is the weakest point of the tubing.

Another issue that has arisen with coiled tubing involves the length of tubing that may be placed on a single reel. It is apparent that the largest diameter reel may not hold the length of tubing that may be needed for use in deeper wells. The diameter of the reel is limited by the largest diameter that may be transported on public roads as well as the equipment that transports the reels to sometimes very remote locations. Reels of coiled tubing may need to be joined together in the field in order to have the length that may be needed for deeper wells. Welding different reels of coiled tubing together is not desirable at the manufacturer location or the field location since the weld may not be biased, resulting in substantial loss of joint strength. While it is possible to join coiled tubing using a roll-on connector, it produces a joint that may only be capable of being coiled a few times.

The problems with coiled tubing therefore include difficulty in repairing existing tubing that is already coiled, and difficulty in joining multiple coils together. If the coiled tubing is going to be replaced, the production of one or more wells is stopped while waiting for additional reels to be shipped. This wait may be as long as several months. Since these reels of coiled tubing are expensive, the industry chooses not to carry large amounts of inventory to meet the needs of all of the wells requiring the coiled tubing.

### BRIEF SUMMARY

The present invention is a system and method for repairing and/or joining together multiple reels of tubular, for example coiled tubing, using friction stir joining using a combination of a disposable or reusable mandrel to react the loads from friction stir joining, and a system for manipulating the coiled tubing so that friction stir joining may be performed while the coiled tubing is on a reel and/or at a field site.

These and other embodiments of the present will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is a perspective illustration of the prior art showing friction stir welding of workpieces.

FIG. 2A is a profile view of a plurality of hard mandrel segments that are separate from each other but form the outline of a circular shape.

FIG. 2B is the profile view of the plurality of hard mandrel segments from FIG. 2A which are brought together to form a circular hard mandrel portion of the reusable and disposable mandrel.

FIG. 3 is a close-up and perspective view of a first embodiment of a single segment of the plurality of hard mandrel segments.

FIG. 4 is a perspective view of a first embodiment of the supporting mandrel portion of the reusable and disposable mandrel.

FIG. 5 is a perspective view of a combination of the supporting mandrel portion of the disposable mandrel and the first segment of the plurality of hard mandrel segments.

FIG. 6 is a perspective view of the plurality of hard mandrel segments forming a continuous outer ring.

FIG. 7 is a cut-away perspective view of the completed disposable mandrel formed as a combination of the supporting mandrel portion and the plurality of hard mandrel segments that form the hard mandrel portion.

FIG. 8 is a perspective view showing the disposable mandrel inserted into the end of a first tube.

FIG. 9 is a perspective view of the tubing with the ends flush, and the joint between them is positioned over the hard mandrel portion of the reusable and disposable mandrel.

FIG. 10 is a top view showing the hard mandrel segments that are offset from each other in order to provide support under a bias joint.

FIG. 11 is a profile view showing the tubing and an inner sleeve disposed within the tubing that may be made part of the tubing during friction stir joining.

FIG. 12 is a profile view showing hard mandrel segments formed as wedge-shaped segments that form a complete circle, and are placed inside the tubing at the joint that is to undergo friction stir joining, and then knocked out of place using one of the methods previously described.

FIG. 13 is a perspective view of a completely reusable mandrel comprised of wedge-shaped hard mandrel segments that when brought together include a conical aperture that is fitted with a plug during friction stir joining, and then the plug is removed by a projectile.

FIG. 14 is a profile view showing wedge-shaped support mandrel segments that form a complete circle, and an outer arrangement of hard mandrel segments, all the segments being knocked out of place after friction stir joining.

FIG. 15 is a profile view of a single hard mandrel ring that is either left in place after friction stir joining, or flushed down the tubing using a projectile to break the ring.

FIG. 16 is an illustration of an embodiment showing a fixture machine in combination with a friction stir joining machine, as coiled tubing is inserted into a well bore.

FIG. 17 is a close-up illustration of the embodiment shown in FIG. 12, showing detail of the fixture machine and the friction stir joining machine.

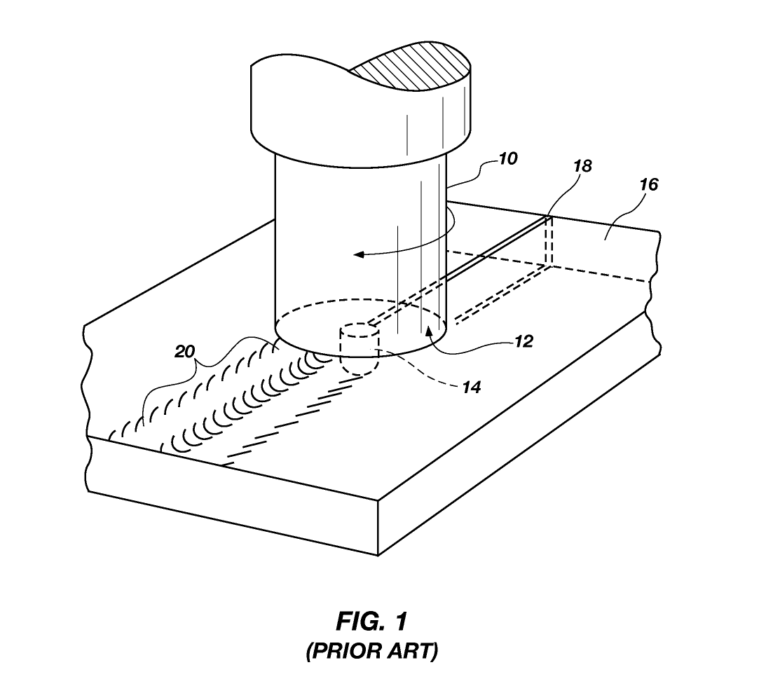

### DETAILED DESCRIPTION

Reference will now be made to the drawings in which the various embodiments will be given numerical designations and in which the embodiments will be discussed so as to enable one skilled in the art to make and use the embodiments of the invention. It is to be understood that the following description illustrates embodiments of the present invention, and should not be viewed as narrowing the claims which follow.

This first embodiment describes a disposable mandrel that may be used to react the loads that are created by a friction stir joining tool against coiled tubing. In this and other embodiments, the mandrel may be completely disposable, partially disposable and partially reusable, or completely reusable. If there is a portion of the mandrel which is disposable, that portion may dissolve or fracture into pieces. If there is a portion of the mandrel which is reusable, that portion may be a smaller component of a mandrel that may disassemble so as to be flushable from the coiled tubing and be reusable.

The coiled tubing may need to be prepared for the friction stir joining process. For example, a section of coiled tubing may be non-compliant and may require repairing because of a crack or other damage that is allowing the coiled tubing to leak a fluid that is passing through. The damaged section of tubing may be removed, resulting in two tube ends that may be joined using friction stir joining and a mandrel of the present invention. The tube ends may be prepared using techniques that are known to those skilled in the art or are as described in the co-pending application titled FRICTION STIR JOINING OF CURVED SURFACES and filed on May 14, 2012, and having Ser. No. 61/646,880. The tube ends may be prepared for a fit and alignment that is suitable for friction stir joining.

A removable or disposable mandrel may be used when performing friction stir joining on tubing because it may be difficult to reach in and push through or pull out a state of the art mandrel because of the large distances that a repair might be performed from the ends of the coiled tubing. Accordingly, one or more embodiments of the present invention may describe the use of a reusable and disposable mandrel, a reusable mandrel, or a disposable mandrel, that may be inserted far from the end of some coiled tubing and then removed. Removal of the mandrel enables continued use of the coiled tubing.

A first embodiment describes a first mandrel having a partially reusable portion and a partially disposable portion of a reusable and disposable mandrel (see FIG. 5). The reusable and disposable mandrel 28 has at least two elements, a hard outer reusable mandrel (hereinafter “hard mandrel portion”) and a removable supporting interior disposable mandrel (hereinafter “supporting mandrel portion”).

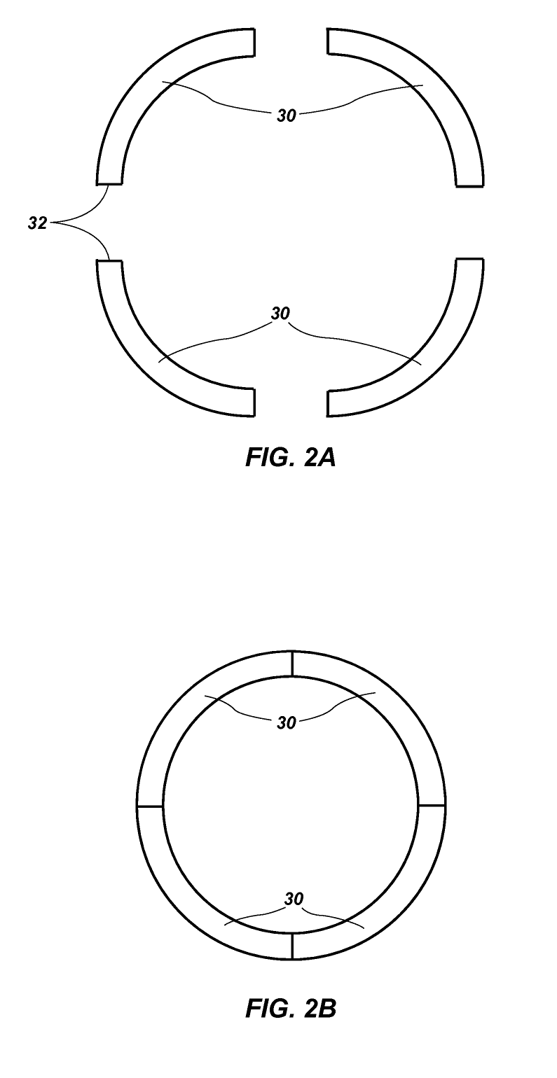

FIG. 2A is a first example of the reusable portion of the reusable and disposable mandrel 28. The hard mandrel portion may be formed from a plurality of separate hard mandrel segments 30, wherein “hard” is defined as capable of reacting the loads and withstanding the heat of friction stir joining. The plurality of hard mandrel segments 30 form the portion of the reusable and disposable mandrel 28 that provides a reactive force directly under the friction stir joining tool at a joint between two ends of tubing that is being joined by friction stir joining.

FIG. 2A is a profile view of the plurality of hard mandrel segments 30 that are separate from each other but which form the outline of a circular shape that matches the inside diameter (ID) of the coiled tubing.

The circular shape should not be considered limiting and is for illustration purposes only. The plurality of hard mandrel segments 30 may be designed so as to conform to the shape of any tubing that is going to be joined or repaired. Furthermore, the number of hard mandrel segments 30 is not limited to the number shown. There may be as few as one hard mandrel segment 30 and no upper limit on the total number of segments that may be used to form a hard mandrel portion of the reusable and disposable mandrel 28. For example two, three, four, five, six, or more hard mandrel segments 30 may be combined to form a single hard mandrel portion of the reusable and disposable mandrel 28. The hard mandrel segments 30 may have the longest cord dimension that still allows them to move freely down the tubing.

In the first embodiment, the hard mandrel segments may have a thermal expansion rate that is equal to or greater than the thermal expansion rate of the tubing.

While it is likely that the hard mandrel segments 30 may travel down the tubing without breaking, it is another aspect of this embodiment that the hard mandrel segments may be breakable in order to remove them from the tubing, or to facilitate travel down the tubing. The hard mandrel segments 30 may be broken by any means that does not damage the tubing, including the use of ultrasonic waves, sonic waves, direct impact and indirect impact.

FIG. 2B is a profile view of the plurality of hard mandrel segments 30 brought together to form the hard mandrel portion of the reusable and disposable mandrel 28. The plurality of hard mandrel segments 30 are capable of providing the reactive force to the friction stir joining tool, and capable of withstanding the heat that is generated while the tubing is being joined using friction stir joining.

Once the tubing is joined, the plurality of hard mandrel segments 30 require removal. A flow of liquid past the plurality of hard mandrel segments 30 may be sufficient to break apart the assembled shape that they may form in FIG. 2B during friction stir joining. Thus, in this first embodiment, the plurality of hard mandrel segments 30 are not attached to each other but are in contact with each other. Therefore, it is a feature of the first embodiment that the touching surfaces 32 (see FIG. 2A) between the plurality of hard mandrel segments 30 may be made at such angles so that when a liquid flows past the plurality of hard mandrel segments after the supporting mandrel portion is weakened or gone, they may flow through the tubing without hindrance.

Therefore, the angle shown for the touching surfaces 32 is for illustration purposes only and should not be considered as limiting. The angle of the touching surfaces 32 may be changed as needed in order to comply with the requirement that the hard mandrel segments 30 be able to come apart if a liquid flows past them in the tubing.

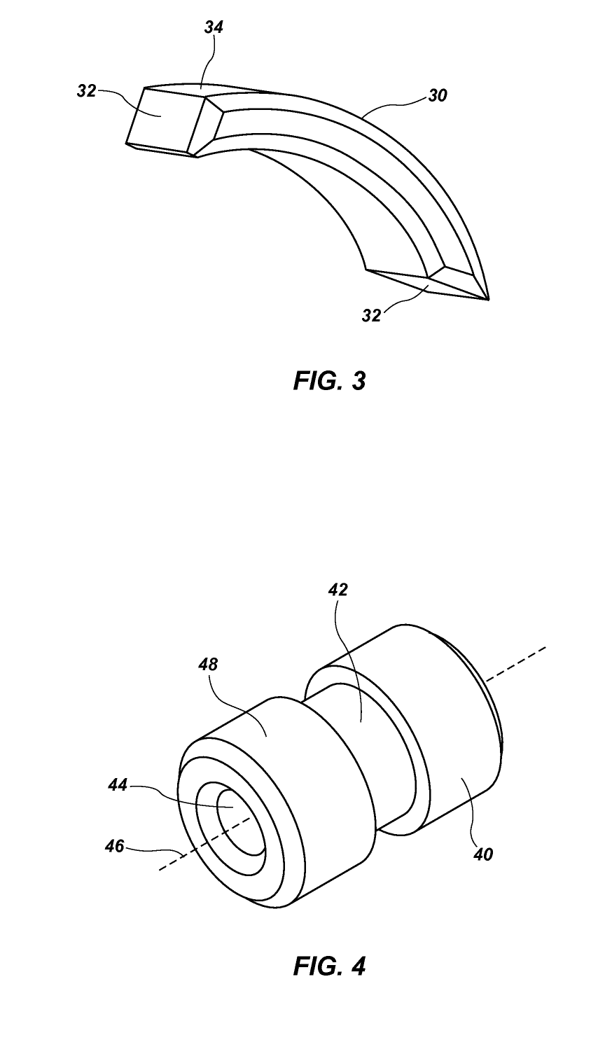

FIG. 3 is a close-up and perspective view of a single segment 30 of the plurality of hard mandrel segments. This shape of the single segment 30 should not be considered limiting but is for illustration purposes only. In order to provide the desired reactive force, the outer curved surface 34 of each of the plurality of hard mandrel segments 30 may be made so as to be concentric and coincident with the inside diameter of the tubing.

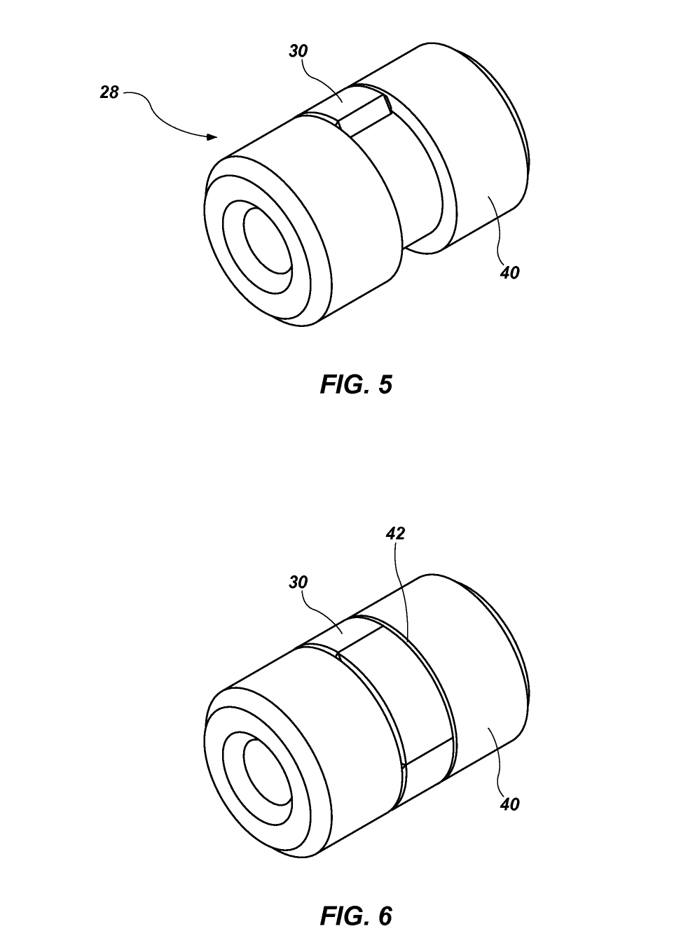

FIG. 4 shows that the reusable and disposable mandrel 28 also includes the supporting mandrel portion 40 which is the disposable part of the mandrel. The supporting mandrel portion 40 may be used as a support or framework for the hard mandrel portion while friction stir joining is being performed. Once friction stir joining is performed on the tubing, the reusable and disposable mandrel 28 may be removed so that the tubing may perform its function of allowing fluids to flow through it without obstruction from the reusable and disposable mandrel 28.

The reusable and disposable mandrel 28 having a hard mandrel portion provides the reactive force and heat tolerance to perform friction stir joining of the tubing. In this first embodiment, the supporting mandrel portion 40 may be dissolvable, thereby allowing the plurality of hard mandrel segments 30 to be removed by the flow of a liquid through the tubing. For example, water may be used as the liquid for dissolving the supporting mandrel portion 40.

FIG. 4 is a perspective view of the first embodiment of the supporting mandrel portion 40 of the reusable and disposable mandrel 28. There are several features of the supporting mandrel portion 40 that will be identified as relevant to the function of the reusable and disposable mandrel 28.

A first feature is that the supporting mandrel portion 40 includes at least one channel 42 or groove that enables placement of the plurality of hard mandrel segments 30 in a position for friction stir joining. By creating the channel 42, the plurality of hard mandrel segments 30 will not come apart prematurely before friction stir joining is complete. The precise location of the channel 42 is not limited by the channel shown in FIG. 4.

For example, the supporting mandrel portion 40 is shown as having the channel 42 that is centered between the ends of the reusable and disposable mandrel 28. However, the channel 42 may be disposed nearer to an end of the reusable and disposable mandrel 28 or on an end thereof. The plurality of hard mandrel segments 30 may be supported during friction stir joining by the supporting mandrel portion 40 anywhere along its length. The example of centering the channel 42 along the length of the supporting mandrel portion 40 should not be considering limiting.

A second feature of the supporting mandrel portion 40 is that the shape may be substantially cylindrical so that it may easily fit within cylindrical tubing being joined and/or repaired. However, it should be understood that the shape of the supporting mandrel portion 40 may be changed to match the ID of the tubing. Thus, the supporting mandrel portion 40 may have a cross-sectional shape other than a circle without departing from the scope of the first embodiment. The cross-sectional shape may be made to match the interior cross-section of any tubing.

The channel 42 is generally going to be made to a depth such that after the plurality of hard mandrel segments 30 are inserted, the outer curved surface 48 of the supporting mandrel portion 40 and the outer curved surface 34 of the plurality of hard mandrel segments may be flush. This configuration may further prevent the reusable and disposable mandrel 28 from sliding inside the tubing during friction stir joining. However, it should also be understood that at least the plurality of hard mandrel segments 30 will be flush against the ID of the tubing.

In an alternative embodiment, the hard mandrel segments 30 may include small projections on an underside that may fit in a corresponding indentation in the supporting mandrel portion 40 to further anchor the hard mandrel segments until they are ready to flow down the tubing.

A third feature of the supporting mandrel portion 40 is an aperture 44 through the center and along an axis 46 that is parallel to the tubing. The aperture 44 enables a liquid to flow completely through the supporting mandrel portion 40. The flow of liquid may be used to dissolve whatever portion of the supporting mandrel portion 40 is dissolvable, such that it no longer continues to hold the plurality of hard mandrel segments 30 in place or in the assembled shape. Even if the flow of liquid does not completely dissolve the supporting mandrel portion 40, enough may be dissolved to enable the plurality of hard mandrel segments 30 to not keep their assembled shape and to instead flow down the tubing as separated hard mandrel segments.

FIG. 5 is a perspective view of the reusable and disposable mandrel 28 as a combination of the supporting mandrel portion 40 and a first segment 30 of the plurality of hard mandrel segments after it is disposed in the channel 42.

While the embodiment above describes a hard mandrel portion formed of a plurality of hard mandrel segments 30, in an alternative embodiment the plurality of hard mandrel segments do not form a continuous ring around the reusable and disposable mandrel 28.

FIG. 6 is a perspective view of the reusable and disposable mandrel 28 with a complete ring of hard mandrel segments 30 in the channel 42 of the supporting mandrel portion 40. The plurality of hard mandrel segments 30 may be held in place while the reusable and disposable mandrel 28 is being put into position in the tubing by one of several methods. For example, an adhesive may be placed between the supporting mandrel portion 40 and the plurality of hard mandrel segments 30, but not between the plurality of hard mandrel segments. In another embodiment, the plurality of hard mandrel segments 30 may use an interference fit in the channel 42, or use a combination of the adhesive and the interference fit. These examples should not be considered as limiting the methods that may be used to hold the plurality of hard mandrel segments 30 in place.

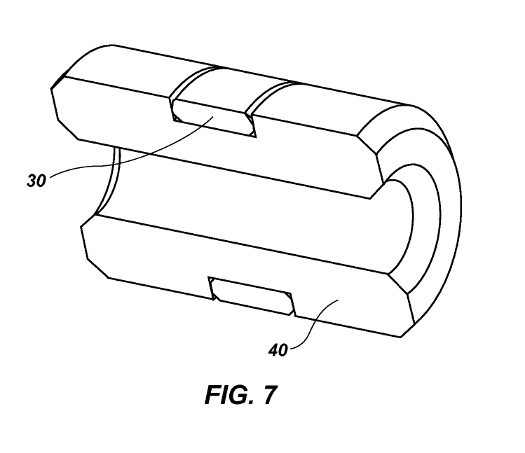

FIG. 7 is a cut-away perspective view of the completed reusable and disposable mandrel 28 of FIG. 6, including the plurality of hard mandrel segments 30 and the supporting mandrel portion 40.

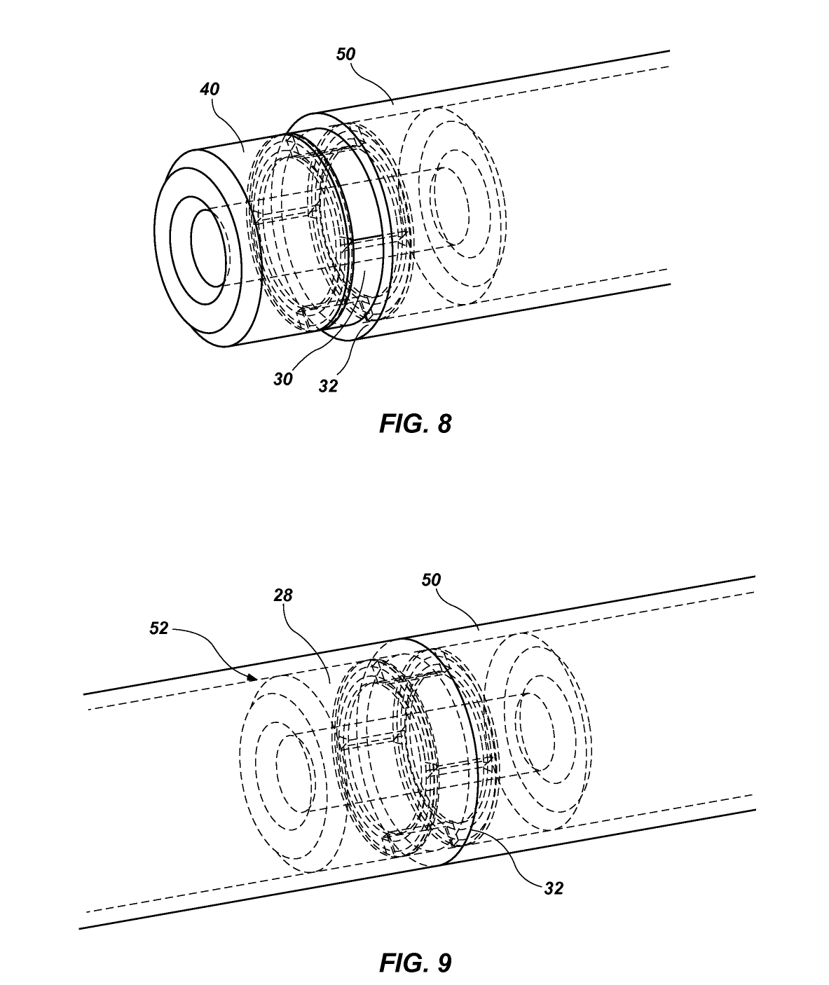

FIG. 8 is a perspective view of one end of a first tube 50 and a portion of the reusable and disposable mandrel 28. This figure shows that once the reusable and disposable mandrel 28 is completely assembled with the plurality of hard mandrel segments 30 disposed in the supporting mandrel portion 40, the reusable and disposable mandrel is inserted into the first tube 50 so that approximately half of the plurality of hard mandrel segments 30 are covered by the end of the first tube 50.

The end of the first tube 50 should cover a portion of the plurality of hard segments 30 whether the joint 32 is on a bias or is going to be a butt weld. The plurality of hard segments 30 should not slide so that they remain under the joint 32 formed by the first tube 50 and a second tube (not shown).

FIG. 9 is a perspective view of one end of the first tube 50, one end of a second tube 52 and a portion of the reusable and disposable mandrel 28. After the reusable and disposable mandrel 36 is inserted into the first tube 50 so that approximately half of the plurality of hard mandrel segments 30 are covered by the end of the first tube 50, the second tube 52 is slid onto the other half of the plurality of hard mandrel segments 30, thereby completely covering the reusable and disposable mandrel 36. The first tube 50 and the second tube 52 are now ready to be joined using friction stir joining. It should be understood that the first tube 50 and the second tube 52 should be flush, and the joint 32 between them should be positioned over the hard mandrel portion 30 of the reusable and disposable mandrel 28.

Once friction stir joining of the tubing is complete, the reusable part of the reusable and disposable mandrel 28 may be removed. A liquid may be flushed through the tubing so that it passes through the aperture 44 in the supporting mandrel portion 40. In a first embodiment, the liquid may be a material that is corrosive to the supporting mandrel portion 40 that will at least partially dissolve, if not completely, the supporting mandrel portion. For example, if the supporting mandrel portion 40 is comprised of aluminum, then hydrochloric acid or potassium hydroxide may be used as the dissolving liquid. Before the supporting mandrel portion 40 is completely gone, the plurality of hard mandrel segments 30 may fall off the supporting mandrel portion and begin to flow with the liquid through the tubing.

The material used for the supporting mandrel portion 40 is not limited to aluminum. Aluminum is used for illustration purposes only. The supporting mandrel portion may be manufactured of any suitable material that will provide sufficient support for the plurality of hard mandrel segments 30 during friction stir joining, but also be capable of being dissolved sufficiently to allow the plurality of hard mandrel segments to come apart and flow through the tubing after friction stir joining.

The plurality of hard mandrel segments 30 may be metallic or non-metallic (i.e. carbide, ceramic, hardened alloy steel, etc.). The plurality of hard mandrel segments 30 may also be coated with a material that functions as a diffusion barrier to prevent the plurality of hard mandrel segments 30 from attaching to the interior of the tubing during friction stir joining.

Regardless of whether the supporting mandrel portion 40 is metallic or non-metallic, it may be dissolved or fractured by a single method or by a combination of methods that include but are not limited to being: dissolved by an acid or a base; dissolved by water or other liquid, by a vapor, a particulate or any combination thereof; melted and then dissolved; frozen and then fractured; fractured without being frozen; fractured by ultrasonic waves; sonic waves or ultralow frequency waves including random and variable frequencies; fractured using magnetic methods, harmonics, resonance, and direct or indirect impact; fractured by coiling of the tubing; and fractured by deformation.

Other materials that may be used for a supporting mandrel portion 40 that may be dissolved include, but should not be considered as limited to, a dissolvable aluminum, a salt that may be compacted into a tube structure, sand with a dissolvable adhesive, a dissolvable adhesive such as honey, or combinations of these materials.

Internal impacts may be caused by a projectile inserted into and sent through the tubing that may fracture or remove one or more of the plurality of hard mandrel segments 30, or even shatter the plurality of hard mandrel segments and/or the supporting mandrel portion 40. The entire reusable and disposable mandrel 28 or any portion thereof might also be moved or flushed in the tubing by a fluid such as a gas or a liquid, by a solid, or by any combination thereof. The projectile may be metallic, non-metallic and any convenient shape. For example, a ball-bearing may be used as the projectile.

One aspect of preparing tubing for friction stir joining has to do with the path of the joint. For example, coiled tubing may be disposed into long and continuous coils for downhole use in wells. Different segments of coiled tubing are often joined together by coupling the segments using a bias weld in order to decrease stress on the joints between segments.

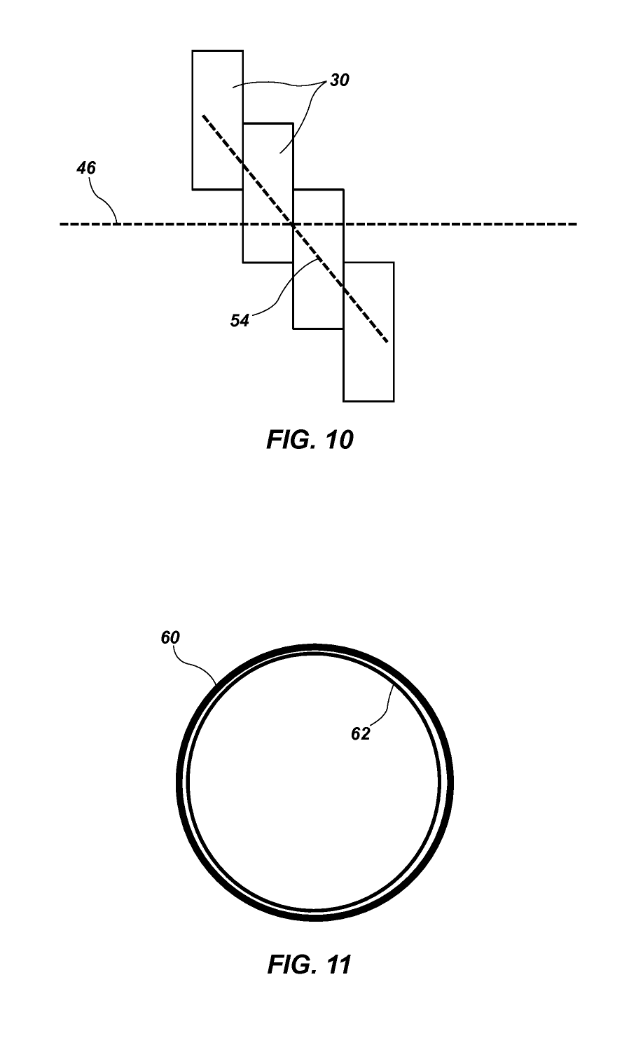

Thus, it should be understood that the plurality of hard mandrel segments 30 of the disposable mandrel may not be aligned to make a circular shape. Instead, the plurality of hard mandrel segments 30 may be offset from each other as shown in FIG. 10. FIG. 10 shows the plurality of hard mandrel segments 30 if they were to be flattened and laid next to each other as they would be arranged on a supporting mandrel portion 40. The bias joint that the plurality of hard mandrel segments 30 would be supporting is shown as the dotted line 54. The dotted line 46 indicates the long axis of the tube in which the reusable and disposable mandrel 28 would be disposed.

FIGS. 2A through 10 describe a reusable and disposable mandrel 28. However, the combination of both a partially reusable portion and a partially disposable portion of a reusable and disposable mandrel 28 are not required in order to provide a mandrel that may be disposed of even when it is unreachable from an end of a long tube.

In an alternative embodiment, the entire mandrel may be made of a dissolvable material. By giving the dissolvable mandrel sufficient structural strength, it may be possible that the dissolvable mandrel may last long enough to perform the friction stir joining before failing. Materials that may be used for the dissolvable mandrel are listed above.

FIG. 11 shows in an alternative embodiment, in a view into the end of a tube 60, that an internal sleeve 62 has been inserted. The internal sleeve 62 may be pressed against the ID of the tube 60 in the location that a mandrel would be inserted. The internal sleeve 62 is then friction stir welded into place inside the tube 60 as the tube undergoes friction stir joining. The internal sleeve 62 is then left inside the tube 60 instead of being removed after the joining or repairing of the tube. Such an internal sleeve 62 may be constructed of a metal or a non-metallic material. In other embodiments, the internal sleeve 62 may be dissolved as described previously, or it may be removed by electrolysis or reverse plating. It is noted that any space between the tube 60 and the internal sleeve 62 is exaggerated for illustration purposes only. There may be no space between tube 60 and the internal sleeve 62 in actual use.

However, in another alternative embodiment, all of the structural elements of a reusable mandrel 70 may be recoverable for use again. While some embodiments above are focused on the use of a mandrel that is dissolvable, partially dissolvable or even breakable, in a different embodiment, a mandrel that is not dissolvable or breakable may also be used.

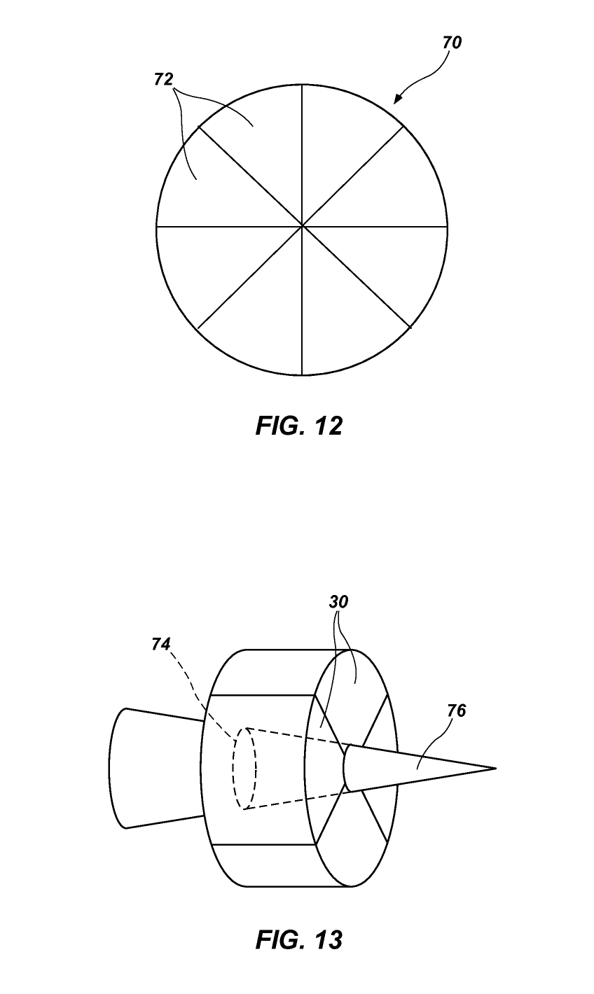

FIG. 12 shows a profile view of another embodiment in which a disposable mandrel may be replaced with a reusable mandrel 70 that is constructed entirely of a plurality of hard mandrel segments 72 that may temporarily support each other. The plurality of hard mandrel segments 72 are each formed as wedge-shaped segments that form a complete circle, which are then placed inside tubing at a joint that is to undergo friction stir joining. After friction stir joining is performed on the tubing, the wedge-shaped hard mandrel segments 72 are knocked out of place using one of the methods previously described, such as by a projectile inserted into the tubing. The projectile flows through the tubing until it impacts the plurality of hard mandrel segments 72. While the example in FIG. 12 shows a total of eight wedge-shaped hard mandrel segments 72, the number of segments used to form the completely reusable mandrel 70 may vary and should not be considered to be a limitation of this embodiment.

FIG. 13 is a perspective view showing a plurality of hard mandrel segments 30 formed as wedge-shaped mandrel segments. When the wedge-shaped mandrel segments 30 are in place, a conical hole 74 is formed through the center of the wedge-shaped mandrel segments 30. A conical plug 76 is inserted into the hole 74. The wedge-shaped mandrel segments 30 are only held in place as long as the plug 76 is in place. However, once friction stir joining is complete, a projectile is sent through the tubing. When the projectile makes impact with the plug 76, the plug is dislodged from the hole 74. Once the plug is removed, the wedge-shaped mandrel segments 30 are designed to fall apart and flow down the tubing with the plug 76 and the projectile.

It should be understood that the number of wedge-shaped hard mandrel segments 30 may vary in order to make them small enough to travel down the tubing after being hit and dislodged by the projectile. The conical plug 76 may also be modified in its shape and dimensions. FIG. 13 is for illustration purposes of the principles only, and should not be considered to be a limiting rendering.

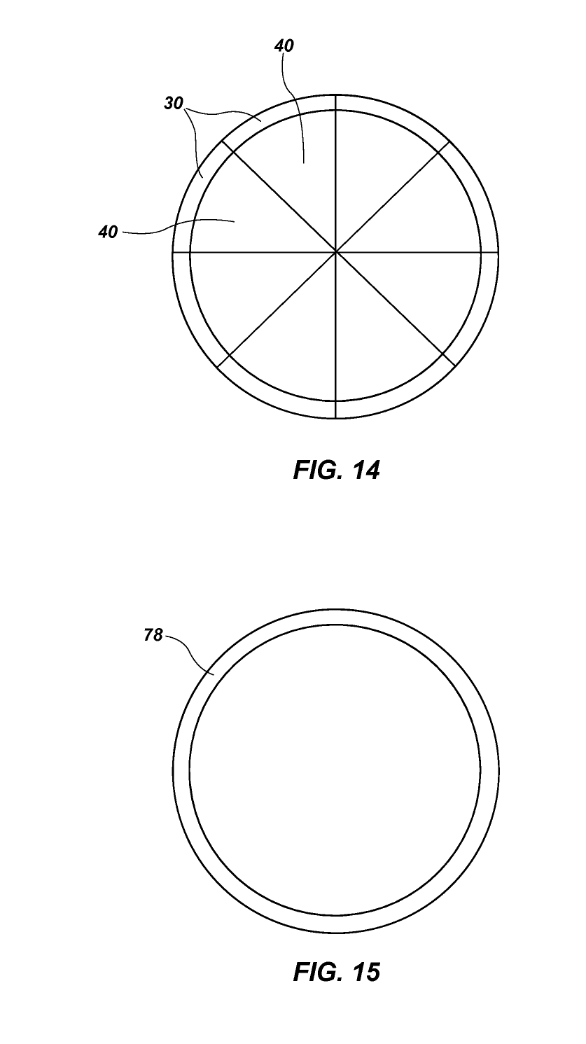

FIG. 14 is a profile view of another embodiment of the present invention. While some embodiments describe a dissolvable supporting mandrel portion 40, another embodiment is the use of a combination of a supporting mandrel portion 40 and a hard mandrel portion 30 of a mandrel where the supporting mandrel portion is not dissolved. This embodiment may also be reusable. In this embodiment, the wedge-shaped hard mandrel pieces 30 may be formed from a material used for the supporting mandrel portion 40, and an outer material formed from the material used for the hard mandrel portion. These wedge-shaped hard mandrel pieces 30 may be held together with an adhesive. After friction stir joining, the wedge-shape hard mandrel pieces 30 are dislodged by impact and may float down the tubing with the supporting mandrel portion.

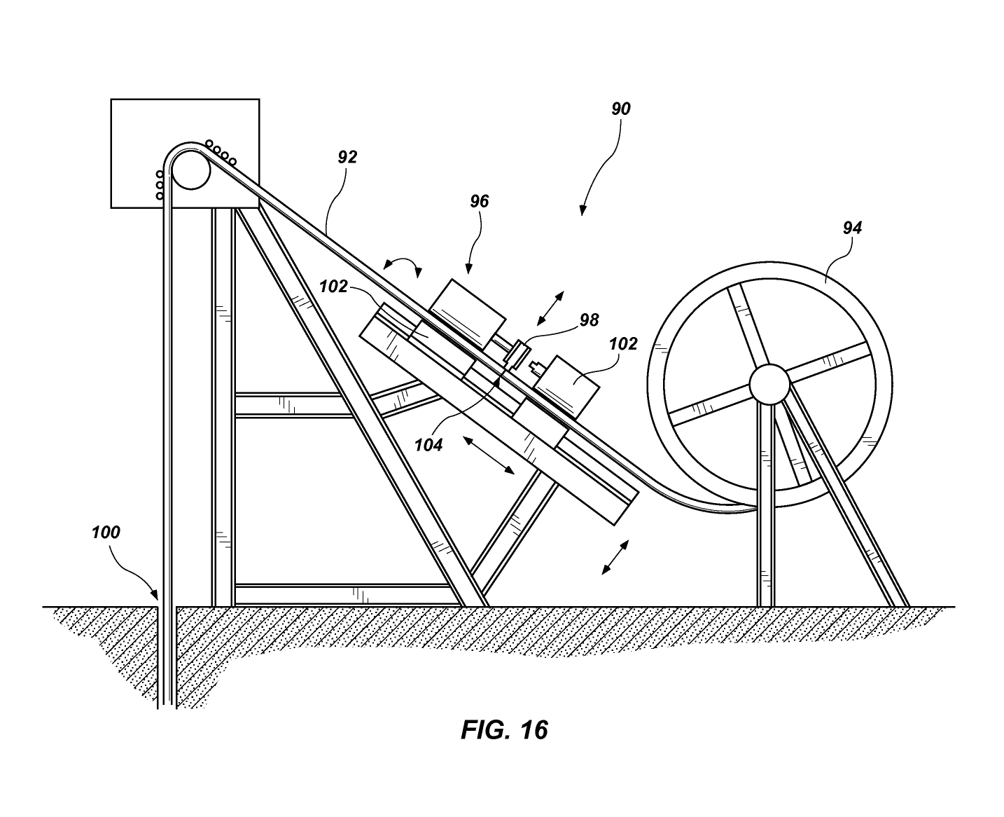

FIG. 15 is a profile view of another embodiment of the present invention. In this embodiment, the hard mandrel segments are replaced with a single hard mandrel ring 78 with no supporting mandrel portion. The hard mandrel ring 78 is inserted into the tubing under the joint that is being welded using friction stir joining. However, unlike being welded into place like the internal sleeve, the hard mandrel ring 78 is washed down the tubing after being broken into fragments using one of the methods described above, or it may be left in place.

Another embodiment may be the use of a liquid for cooling of the disposable or non-disposable mandrel during friction stir joining. The cooling may enable the fracturing of the disposable or non-disposable mandrel in order to remove them after friction stir joining. In another embodiment, both the hard mandrel segments and the supporting mandrel portion may be positioned together using adhesive that is sublimated by temperature and parts are removed by flushing as described above.

In another embodiment, it may also be possible to attach a wire to a non-disposable mandrel. The wire may then be used to retrieve the non-disposable mandrel after friction stir joining of the tubing.

In another embodiment, it may also be possible to provide a non-disposable mandrel that may be operated by remote control in order to remove it from the tubing. For example, the non-disposable mandrel may include a motorized drive mechanism that enables the non-disposable mandrel to push or pull itself through the tubing. Operation of the motorized drive mechanism and any other controllable elements of the non-disposable mandrel may be controlled by an operator. Other controllable elements may include a system for expanding and retracting the hard mandrel portion in order to engage the ID of the tubing in order to perform friction stir joining.

Similarly, the non-disposable mandrel may be able to autonomously control its own movement using a motorized drive mechanism that enables the non-disposable mandrel to push or pull itself through the tubing and exit the tubing after friction stir joining. The autonomous control may also include a system for expanding and retracting the hard mandrel portion in order to engage the ID of the tubing.

At least a portion of the disposable and non-disposable mandrels may be resized. Resizing may be possible, for example, using cold swaging, thereby adjusting roundness, ovality and distortions.

At least some of the embodiments have been directed to the aspect of joining or repairing the tubing. However, the removable mandrel may also be used to perform another variation of friction stir joining, including but not limited to friction stir processing (FSP), friction stir mixing (FSM), and friction stir spot welding (FSSW). Thus if the tubing does not have a hole but has wear or other damage on the tubing that will likely result in failure at some time, the tubing may be friction stir processed to prevent tube failure without having to cut away all of the damaged tubing. The tubing is cut and a mandrel is inserted. Friction stir processing is performed on the tubing, and then friction stir joining is performed to re-join the tubing.

The embodiments above may be used when performing friction stir joining on a tubular such as coiled tubing where it may be impractical to insert a mandrel that is not disposable. Accordingly, an embodiment is directed to a system that enables friction stir joining or repair of coiled tubing that is spooled on a reel. Nevertheless, the principles of this and other embodiments may be applicable to tubulars in general.

Another aspect of the invention is the use of a system 90 for manipulating coiled tubing 92 so that friction stir joining or a variation thereof may be performed while the coiled tubing is on a reel 94. Unlike some friction stir embodiments where friction stir welding is performed in a manner that is very similar to other types of welding, this embodiment is directed to welding that may be treated more like machining because of the degree of precision that is useful when working with the coiled tubing 92.

The system 90 of this embodiment is shown in profile view in FIG. 16. FIG. 16 shows a reel 94 of coiled tubing 92. The coiled tubing 92 is being fed off the reel 94, through a fixture machine 96 and a friction stir joining machine 98, through an injector and down into a well borehole 100. It should be understood that this view is for illustration purposes only and the position of the components of the system 90 shown may be altered by those skilled in the art without departing from this embodiment.

The system 90 shown in FIG. 16 may include the fixture machine 96 that holds and aligns the tubular 92. The tubular 92 may be in tension, compression, torsion, or neutral. Thus, the fixture machine 96 may clamp onto both ends of the tubing 92 that have been prepared for friction stir joining, and then manipulate the tubing under any of these or other conditions. Therefore, the fixture machine 96 at least includes one or more clamping mechanisms 102 for holding and aligning two ends of the coiled tubing 92 to be coupled using friction stir joining.

The fixture machine 96 may not be limited only to clamping and aligning of the tubular 92. A clamp is typically a device that holds an object in position for such activities as joining, processing, or assembling. However, in this embodiment, the fixture machine 96 may also be capable of forming the tubular 92 while holding. Forming is made possible because the fixture machine 96 may include independently controlled clamping sections that may compress, squeeze, flatten, deform or otherwise elastically or plastically manipulate the shape of the tubular 92 as desired.

In order to be able to manipulate a shape of the tubular 92, the fixture machine 96 may be capable of applying large forces to the tubular, and to different portions of the tubular. The fixture machine 96 may also be capable of supporting substantial amounts of weight in order to manipulate the tubular 92. Accordingly, the fixture machine 96 may provide robust and precision holding, forming, and aligning of the tubular 92. The clamping forces may be provided by pneumatic, hydraulic or any other mechanical force that may apply the desired pressures in a precision manner.

The fixture machine 96 maintains the alignment and position of the tubular 92 such that a single cut may be made, or multiple cuts may be made, in order to remove a section of tubular. Thus in preparing for friction stir joining, the fixture machine 96 allows for axial movement of the tubular 92 in order to perform procedures including but not limited to reaming, facing, any other surface preparation of the ends of the tubular to be joined, mandrel insertion, resizing (i.e. swaging), and making the tubular round or another desired cross-sectional shape. Therefore the fixture machine 96 includes rotational means for rotation of the coiled tubing 92 if rotation is possible, and allowing access to the ends of the coiled tubing so they may be prepared for friction stir joining.

The fixture machine 96 may be a stand-alone machine or it may be combined with another machine such as a friction stir joining system 98 as shown in FIG. 16. The fixture machine 96 may be portable or stationary. If portable, the fixture machine 96 may be operated at a remote location such as a well bore where the coiled tubing 92 to be modified is located and possibly in use. In one or more embodiments, the fixture machine 96 is a mobile or portable device that operates in a stand-alone configuration or in combination with another device. Portability of the fixture machine 96 means that it is capable of being transported where it is needed in the field or at a more permanent facility. Transportation is possible by land, water or air, and so includes transportation by truck, barge, plane, helicopter, crane, etc.

In one or more embodiments, the fixture machine 96 may be oriented substantially horizontal, substantially vertical, or any orientation in between. The fixture machine 96 may include a means for orienting the coiled tubing 92 into a useful position, for changing the orientation of the coiled tubing being held by the clamping means, as well as operating in any desired orientation itself.

FIG. 16 illustrates an example of use of the fixture machine 96 in combination with a friction stir joining machine 98, but should not be considered as limiting in any aspect of its use or design. The reel 94 of coiled tubing 92 is shown near a well borehole 100, and a portion of the coiled tubing is disposed down the well borehole.

In one aspect of the invention, another reel 94 of coiled tubing 92 may be attached to the tubing already in the well borehole 100 in order to extend the reach of the coiled tubing. The ends of the coiled tubing 92 are thus brought together and held by the fixture machine 96 at a joint 104. A mandrel may or may not be inserted into the tubing 92 at the joint 104. The mandrel is preferably a reusable, a reusable and disposable or a disposable mandrel as described above. While the fixture machine 96 holds the ends of the coiled tubing 92 in a desired position, the friction stir joining machine 98 is placed in position to join the coiled tubing.

Before joining the two coiled tubes 92 together, the ends of the coiled tubes may require processing. The fixture machine 96 of this embodiment is capable of moving an end of the tubular 92 so that it is aligned with an end fixture. The end fixture may include a reaming head for modification of the ID of the tubular 92. The end fixture may include a facing tool or any other tool that is capable of preparing the tubular 92 for friction stir joining.

The example of use of the fixture machine 96 and the friction stir joining machine 98 above is directed to joining coiled tubing 92 when it is being inserted downhole. However, the joining of tubing 92 may be performed at any stage of manufacturing or moving the tubing to a site for use. For example, tubing may be joined using the present invention at the tubing manufacturer site, a storage facility, and at the rig site. At the rig site, the joining of tubing may be performed before insertion, during insertion, during extraction, or after extraction of the tubing 92 into or out of the well borehole 100. In one or more embodiments, repairs to the coiled tubing 92 may be required at any time, such as before insertion, during insertion, during extraction, after extraction, etc.

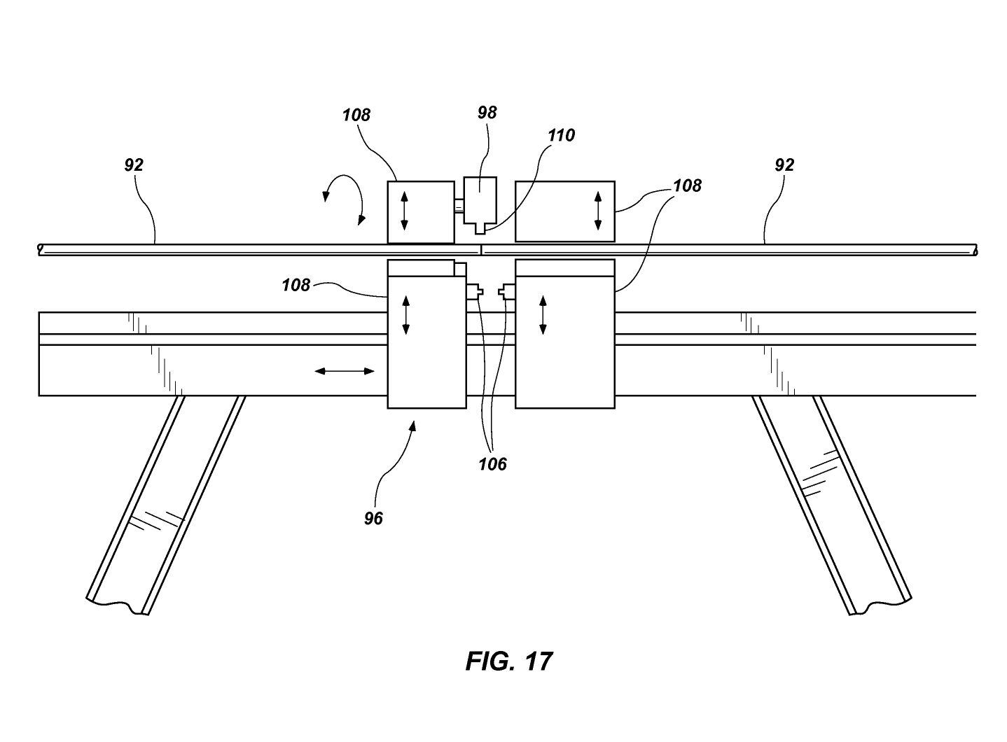

FIG. 17 is provided as a close-up of a combination of the fixture machine 96 and the friction stir joining machine 98. The end fixture tools 106 that may modify the tubular 92 may be placed in any convenient position relative to the tubular, in any desired location on the fixture machine 96.

The tubular 92 is shown as being held by four independently controllable clamps 108. In one or more embodiments, the independently controllable clamps 108 may manipulate the tubular 92 in the Z axis, W axis, and/or Y and/or X axis and U axis or any combination of axis movements before friction stir joining such as during pre-processing of the coiled tubing, during friction stir joining, and after friction stir joining when finishing is being performed. It should also be understood that more independently controllable clamps 108 may be provided as desired, and should not be considered as a limiting factor of this or other embodiments.

The fixture machine 96 may include a friction stir joining tool machine 98 that is shown attached to a portion of one of the independently controllable clamps 108. However, the friction stir joining tool machine 98 may be disposed on a different component of the fixture machine 96, or it may not be attached to the fixture machine at all. The friction stir joining tool 110 may be manipulated to move around the tubular 92 in any manner desired, including in a path that moves around the joint 104 of the two coiled tubes, or the tubular itself may be rotated by the fixture machine 96. The friction stir joining machine 98 may have a track to follow around the tubular 92, or no track may be needed.

In this embodiment, each of the bottom clamps of the independently controllable clamps 108 is shown as each a reaming spindle 106 as an end fixture tool for performing reaming of the tubular 92. The reaming heads are shown facing each other so that the faces of the tubular 92 can each be modified by a reaming spindle 106 or other end fixture tool.

It may be within the scope of this and other embodiments that there may be various options available when using the embodiments of the fixture machine 96 described above. In one or more embodiments, the fixture machine 96 may include temperature control in order to provide heating or cooling of the coiled tubing 92. Heating and cooling may be useful when one or more temperature dependent plugs may be inserted into the coiled tubing 92 when performing friction stir joining. The plug may stop the flow of liquid through a section of the coiled tubing 92, allowing friction stir joining to be performed. The plugs may be heat sensitive and therefore temperature control may be used to remove the plugs once friction stir joining is complete. In one or more embodiments, a plug may be removed by elevating the temperature of the plug to soften the plug material.

One situation that arises when performing friction stir joining of coiled tubing 92 that is on a reel 92, down a well borehole 100, or in both locations, the coiled tubing may not be free to rotate in the fixture machine 96. Accordingly, the fixture machine 96 may be capable of holding the coiled tubing 92 while the friction stir joining tool 110 is rotated around the tubular. However, if the coiled tubing 92 is free to rotate, the fixture machine 96 may also rotate the coiled tubing while the friction stir joining tool 110 is held stationary.

Both the friction stir joining machine 98 and the fixture machine 96 may both be portable devices and either integrated together or function as standalone devices.

In one or more embodiments, the fixture machine 96 may include single or multiple point support that enables the fixture machine to react forces of the friction stir joining tool 110 on the outside of the coiled tubing 92. For example, a roller may be used to manipulate the coiled tubing 92 as needed. The roller may apply a force to create a “bend” that may allow for management of residual or compressive stresses in the joint to thereby manage fatigue properties.

Rollers or other support devices may also elastically form an arc in the coiled tubing 92 during friction stir joining. The plane of the arc may be rotated during friction stir joining as the friction stir joining tool 110 is operated. In other words, a flex may be applied to the ends of the coiled tubing 92 in order to form an arc that is rotated during friction stir joining. The result is that the welding and rotating occur in a non-axial plane and the bend has applied a pre-loading stress on the coiled tubing 92.

In one or more embodiments, the fixture machine 96 may include a location for a runoff tab from the coiled tubing 92. The runoff tab may be automatically positioned as part of the friction stir joining process. In another embodiment, the fixture machine 96 may have a shear to remove a runoff tab after friction stir joining.

The fixture machine 96 may include a post processing system for finishing or otherwise modifying the joint 104 in the coiled tubing 92 after friction stir joining. The finishing may take place on a surface of the coiled tubing 92 or it may affect the interior of the joint 104. The post processing system may include a system for cutting, grinding, polishing, heating or otherwise finishing or treating the tubular 92.

In one or more embodiments, the fixture machine 96 may include a system to impart desirable residual stresses to the joint 104. Residual stresses may be created in the joint 104 by methods that include but are not limited to cold rolling, shot peening and hammer peening.

In one or more embodiments, the fixture machine 96 may provide a tool for swaging the ends of the coiled tubing 92 to give them a larger diameter before performing friction stir joining. After friction stir joining, the coiled tubing 92 may then be swaged back to the original diameter of the coiled tubing.

When operating the fixture machine 96 and a friction stir joining machine 98 as portable devices, it may be useful to be able to attach the fixture machine 96 and/or the friction stir joining machine 98 to other equipment. For example, when the coiled tubing 92 is inserted into a well borehole 100, an injector may be used to feed the coiled tubing 92 from a reel 94 to the well borehole. In one or more embodiments, the fixture machine 96 and the friction stir joining machine 98 may be attached to the injector because joining work or repair work on the coiled tubing 92 may take place between the reel 94 and the well borehole 100 as shown in FIG. 16. However, the fixture machine 96 and the friction stir joining machine 98 may be coupled to any equipment, including any equipment used to service or operate a well, and either before or after the injector. It should also be understood that the orientation of the fixture machine 96 and the friction stir joining machine 98 may be changed between vertical, horizontal or any other axis of orientation. Furthermore, other equipment such as the injector may also assist the fixture machine 96 in bringing the ends of the coiled tubing 92 together for friction stir joining.

As coiled tubing 92 is being used, it may need to be tested before being placed down a well borehole 100 in order to try and catch damage and defects in the tubing before failure occurs. Furthermore the coiled tubing 92 may need to be tested before, during or after a friction stir joining process. In one or more embodiments, the testing equipment may be separate from the fixture machine 96 and the friction stir joining machine 98.

In one or more embodiments, the fixture machine 96 may be capable of performing or assisting in the performance of one or more nondestructive tests or evaluations of the coiled tubing 92 at any time. These tests and evaluations include but should not be considered as limited to: hydrostatic internal testing, hydrostatic external testing, ultrasonic inspection, magnetic flux leakage inspection, X-ray inspection, gamma ray inspection, and positron decay inspection.

As was previously mentioned above, plugs that may be inserted into the coiled tubing 92 may be useful when performing friction stir joining or repair of coiled tubing. Plugs may be inserted into coiled tubing 92 either upstream and/or downstream to contain pressure and/or fluid flow within the tubing. These plugs are used on a temporary basis until friction stir joining or processing is completed. In one or more embodiments, the fixture machine 96 may modify the temperature of the coiled tubing 92 and thereby assist in holding plugs in place or assisting in their removal.

For example, if a freeze plug is used, the coiled tubing 92 may be cooled to keep the freeze plug in place, and warmed when the freeze plug needs to be removed. Likewise, other plug materials may be solid at room temperature, such as a wax plug, but may be removed by heating the coiled tubing 92 and the plug above ambient temperature to cause the plug to fail.

Plugs may melt, undergo a chemical change, or incorporate other materials to improve pressure containing ability. Such materials may include particulate matter, fibers, pins, or solid objects ranging from 5% up to 95% of the tubing diameter. In other embodiments, plug removal may be performed using an elongated member inserted through the coiled tubing 92. The elongated member may be formed from, but is not limited to, a wire, cable, tubing, fiber, fiber reinforced composite rod, or a metal bar.

Plugs may remain in position after friction stir joining in order to test the integrity of welds. Accordingly, a plurality of plugs may be used so that fluid flow down the entire length of the coiled tubing 92 does not need to be resumed in order to test for fluid leaks.

Another embodiment is directed to a configuration of coiled tubing strings. Accordingly, all the applicable embodiments described herein may be applied to two strings of coiled tubing, where one string is disposed inside the other.

Coiled tubing 92 may also be used as a conduit for other objects seeking access down a well borehole 100. These other objects include but are not limited to such items as wireline cable, capillary tubing, fiber optic cable, metal tubing, armored fiber optic cable, electrical conductors, fluid passages, and any combination of the items above, or any other devices with a downhole application. In one or more embodiments, the coiled tubing 92 may be cut in order to gain access to these other items inside the coiled tubing. Cutting the tubing 92 may provide access in order to conduct insertion, repair or removal of the items disposed therein. After insertion, repair or removal, the coiled tubing 92 may be joined using friction stir joining.

In another embodiment, coatings may be used on the 104 joint or the coiled tubing 92. Such coatings may be for many different purposes, but should be considered as including the purposes of preventing diffusion bonding, removal of oil or other contaminants from a joint, or any other purpose that will assist in friction stir joining or repair.

The nature of the use of coiled tubing 92 in the Oil and Gas industries does mean that the coiled tubing is often used in dangerous environments where explosions may be a real possibility. Accordingly, in another embodiment the fixture machine 96, the friction stir joining machine 98 and any other equipment that is being used to work with the coiled tubing 92, it may be designed such that the configuration allows for the prevention of explosions. Explosion prevention may be useful because of the explosive gases that come from well boreholes 100 that may come into contact with the heat that can be generated when performing friction stir joining and processing. Explosion prevention may be accomplished, for example, by enclosing the fixture machine 96 and the friction stir joining machine 98 and purging the enclosed area with an inert gas such as argon or other non-combustible gas.

Various embodiments disclosed herein may be directed to friction stir joining and friction stir processing of coiled tubing 92; however, the various embodiments may be used to join the coiled tubing to objects other than itself. The object may be located at the up-hole end of a coiled tubing string, located at the down-hole end of the coiled tubing string, and located at one or more places in the coiled tubing string and having coiled tubing joined to one or both ends using friction stir joining.

In one or more embodiments, the coiled tubing 92 may be friction stir joined to a pump in sub, a down hole tool connector, a single or dual check valve, and a side flow port.

In one or more embodiments, the coiled tubing 92 is joined to an object by friction stir joining, wherein the object may incorporate external rollers, the object may induce rotation between its two ends, the object may permit rotation between its two ends, the object may enable flexing, the object may be a measurement instrument, a centralizer, a packer, the object may allow an external cable to be attached to the coiled tubing, the object may allow an external cable to be passed from the outside to the inside of the coiled tubing, the object may be magnetic, may be a marker that may be readily detected to allow a point of reference on the coiled tubing, may be a gas lift valve, the object may join two different diameters of coiled tubing, the object may be a section of straight tubing substantially stiffer or more flexible than the coiled tubing, the object may be a sliding sleeve valve, the object may produce vibrations, the object may be a weak point, may be a release joint, may be a jar, or the object may incorporate a fishing neck or a fishing tool.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. §112, paragraph 6 for any limitations of any of the claims herein, except for those in which the claim expressly uses the words ‘means for’ together with an associated function.

What is claimed is:

1. A system comprising:
a fixture machine to hold and align a first end of a first tubular and a second end of a second tubular;
a mandrel disposed inside the first and second tubular to provide a reactive force during friction stir joining; and
a friction stir joining machine for performing friction stir joining of the first and second ends of the first and second tubulars.

2. The system as defined in claim 1 wherein the fixture machine and the friction stir joining machine are integrated into a single portable system.

3. The system as defined in claim 1 wherein the fixture machine further comprises clamps for manipulating the tubular in a Z axis, W axis, and/or Y and/or X axis and U axis, or any combination of axis movements.

4. The system as defined in claim 1 wherein the fixture machine further comprises clamps for elastically or plastically deforming the tubular.

5. The system as defined in claim 1 wherein the fixture machine further comprises at least four independently controllable clamps for deforming the tubular.

6. The system as defined in claim 1 wherein the friction stir joining machine further comprises a friction stir joining tool that rotates around the tubular while the tubular is held stationary by the fixture machine.

7. The system as defined in claim 1 wherein the fixture machine includes temperature control means for changing a temperature of the tubular.

8. The system as defined in claim 1 wherein the system further comprises a roller for manipulating residual or compressive stresses in the joint of the tubular.

9. The system as defined in claim 1 wherein the fixture machine further comprises a post processing system for performing finishing on the tubular.

10. The system as defined in claim 1 wherein the fixture machine further comprises testing equipment for performing one or more nondestructive tests of the tubular.

11. The system as defined in claim 1 wherein the fixture machine further comprises testing equipment that can perform non-destructive tests from the group of non-destructive tests comprised of: hydrostatic internal testing, hydrostatic external testing, ultrasonic inspection, magnetic flux leakage inspection, X-ray inspection, gamma ray inspection, and positron decay inspection.

12. The system as defined in claim 1 wherein the friction stir joining machine further comprises the ability to perform friction stir processing.

13. The system as defined in claim 1 wherein the mandrel further comprises a disposable mandrel.

14. The system as defined in claim 1 wherein the mandrel further comprises a reusable mandrel.

15. The system as defined in claim 1 wherein the mandrel further comprises a partially disposable mandrel and a partially reusable mandrel.

16. The system as defined in claim 1 wherein the mandrel further comprises:
a hard mandrel portion that provides support for friction stir joining; and
a supporting mandrel portion that is at least partially dissolvable.

17. The system as defined in claim 16 wherein the hard mandrel portion is comprised of a plurality of hard mandrel segments.

18. A method for performing friction stir joining of tubular, and comprising:
1) clamping two ends of a tubular in a fixture machine;
2) inserting a mandrel in the tubular along a joint formed by the two ends of the tubular;
3) aligning the two ends of the tubular; and
4) friction stir joining the two ends of the tubular along the joint using a friction stir joining tool.

19. The method as defined in claim 18 wherein the method further comprises using a mandrel that is at least partially dissolvable.

20. The method as defined in claim 18 wherein the method further comprises using a mandrel that is at least partially reusable.

21. The method as defined in claim 18 wherein the method further comprises using a mandrel that is at least partially reusable and at least partially dissolvable.

22. The method as defined in claim 18 wherein the method further comprises removing the mandrel from the tubular by dissolving at least a portion of the mandrel.

23. The method as defined in claim 18 wherein the method further comprises disposing a fluid in the coiled tubing that will cause at least a portion of the mandrel to dissolve.

24. The method as defined in claim 18 wherein the method further comprises providing a plurality of hard mandrel segments on the disposable mandrel that react the forces of friction stir joining, and which flow through the coiled tubing after at least a portion of the disposable mandrel is dissolved.

25. The method as defined in claim 24 wherein the method is further comprised of:
1) forming the joint such that the joint in the tubular is along a bias; and
2) placing a plurality of hard mandrel segments of the mandrel along the bias in the tubular.

26. The method as defined in claim 18 wherein the method is further comprised of sending a projectile through the tubular to thereby remove the mandrel.

27. The method as defined in claim 18 wherein the method further comprises elastically or plastically deforming the tubular by using the clamps.

28. The method as defined in claim 18 wherein the method further comprises independently controlling the clamps in order to elastically or plastically deforming the tubular.

29. The method as defined in claim 18 wherein the method further comprises rotating the friction stir joining tool around the tubular while the tubular is held stationary by the clamps.

30. The method as defined in claim 18 wherein the method further comprises joining together two ends of coiled tubing from different reels of coiled tubing to thereby increase a total length of the tubular.

31. The method as defined in claim 18 wherein the method further comprised of preparing the two ends of the tubular for friction stir joining by using the fixture machine to perform procedures from the group of procedures including: reaming, facing, surface preparation of the ends of the tubing to be joined, resizing (i.e. swaging), and making the coiled tubing a desired cross-sectional shape.

32. The method as defined in claim 18 wherein the method further comprises performing the friction stir joining of the coiled tubing at a field location that is not the place of manufacturing of the coiled tubing.

33. The method as defined in claim 18 wherein the method further comprises testing of the joint using at least one non-destructive test.

34. A method for repairing a non-compliant tubular comprising:
1) removing a portion of the tubular to form at least a first end of a first tubular;
2) aligning the first end of the first tubular with a second end of a second tubular;
3) disposing a mandrel within the first and second tubular along the first and second ends; and
4) performing friction stir joining of the first and second ends to form a FSJ joint.

35. The method as defined in claim 34, wherein the first and second tubular are formed from the non-compliant tubular.

36. The method as defined in claim 34, wherein in the mandrel is a disposable mandrel.

37. The method as defined in claim 34, wherein the tubular is coiled tubing.

38. The method as defined in claim 34, wherein the method further comprises testing the integrity of the FSJ joint.

39. The method as defined in claim 34, wherein the method further comprises post processing the FSJ joint.

40. The method as defined in claim 34, wherein the method further comprises identifying a non-compliant section of the tubular.

41. The method as defined in claim 34, wherein the method further comprises inserting at least one plug within the first or second tubular.

42. The method as defined in claim 34, wherein the method further comprises placing a first plug within the first tubular and placing a second plug within the second tubular.

43. The method defined in claim 42, wherein the plug is removable.
